(19) United States
(12) Patent Application Publication
(10) Pub. No.: US 2025/0385870 A1
(43) Pub. Date: Dec. 18, 2025

(54) TIME-BOUND DYNAMIC SLICING FOR WIRELESS COMMUNICATION NETWORKS

(71) Applicant: T-MOBILE INNOVATIONS LLC, Overland Park, KS (US)

(72) Inventor: Wen-Ping Ying, Bellevue, WA (US)

(21) Appl. No.: 18/745,422

(22) Filed: Jun. 17, 2024

(51) Int. Cl. H04L 47/127; H04L 47/19

(52) U.S. Cl. CPC H04L 47/127; H04L 47/196

(57) ABSTRACT

Systems, methods, and software are disclosed herein for time-bound dynamic slicing for wireless communication networks in various implementations. In an implementation, a computing device receives a request from an application for a network slice including a specified delay and a slice duration. The computing device determines a projected congestion based on a context of the network slice and the slice duration and identifies one or more candidate slices according to the specified delay and the projected congestion.

### TECHNICAL FIELD

Aspects of the disclosure are related to the field of wireless communication networks, particularly selection and allocation of network slices.

### BACKGROUND

Latency or delay in wireless network communication is an important, if not critical, factor that developers of cloud-based extended reality (XR) content face. When determining whether streaming cloud-based XR applications is feasible, developers must consider whether delays in transmissions via wireless network communication will support at least a minimally acceptable user experience. When streaming via 5G (for example, from a hyperscaler host), the delay and jitter of the end-to-end connectivity due to network congestion may make it difficult to maintain an acceptable user experience. The current solution for rendering and streaming XR content from the cloud is to do so as close to the user device as possible to reduce the delay. However, this will hardly be an effective solution in situations where much or most of the communication loop is on-premises via WiFi and therefore not amenable to improvement.

Other potential solutions may only be partially effective and/or cost prohibitive relative to any gains. For example, building out mobile edge or multi-access edge computing networks (for example, by adding more mobile switching facilities) may reduce the delay, but transmissions would still be subject to network traffic conditions, so this would only partially address the problem. Moreover, such a solution is highly cost-prohibitive. And while there have been efforts to create network slices for cloud-based XR content streaming and gaming, the planned slicing mechanism is static. As a result, providing one slice for all XR applications will lead to over-subscription and overuse of radio resources, and it will not be cost-effective for consumer applications.

### OVERVIEW

Technology is disclosed herein for time-bound dynamic slicing for wireless communication networks in various implementations. In one example, a computing apparatus comprises one or more computer readable storage media, one or more processors operatively coupled with the one or more computer readable storage media and program instructions stored on the one or more computer readable storage media that, when executed by the one or more processors, direct the computing apparatus to at least receive a request for a network slice from an application including a specified delay and a slice duration. The computing apparatus determines a projected congestion based on a context of the network slice and the slice duration and identifies one or more candidate slices according to the specified delay and the projected congestion.

In another example, a method of operating a computing device comprises receiving a request from an application for a network slice including a specified delay and a slice duration; determining a projected congestion based on a context of the network slice and the slice duration; and identifying one or more candidate slices according to the specified delay and the projected congestion.

In yet another example of the technology disclosed herein, one or more computer readable storage media having program instructions stored thereon that, when executed by one or more processors, direct a computing apparatus to at least receive a request from an application for a network slice including a specified delay and a slice duration. The computing apparatus determines a projected congestion based on a context of the network slice and the slice duration and identifies one or more candidate slices according to the specified delay and the projected congestion.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for time-bound network slicing in an implementation.

FIGS. 2A and 2B illustrate processes for time-bound network slicing in an implementation.

FIG. 3 illustrates an operational environment for time-bound network slicing in an implementation.

FIG. 4 illustrates a workflow for time-bound network slicing in an implementation.

FIG. 5 illustrates an operational scenario for time-bound network slicing in an implementation.

FIG. 6 illustrates a process for constructing a DSC model for time-bound network slicing in an implementation.

FIG. 7 illustrates an operational architecture of a wireless communication network supporting time-bound network slicing in an implementation.

FIG. 8 illustrates an operational architecture for a wireless communication network supporting time-bound network slicing in an implementation.

FIG. 9 illustrates a computing system suitable for implementing the various operational environments, architectures, processes, scenarios, and sequences discussed below with respect to the other Figures.

### DETAILED DESCRIPTION

Various implementations are disclosed herein for dynamic allocation of wireless network resources for applications, such as cloud-based extended reality (XR) applications, which have demanding requirements with respect to latency in data traffic handling. Such requirements arise because network congestion conditions of a wireless communication network can cause the user experience of time-critical applications to be degraded. However, network congestion conditions can vary with the day, time, and location or region of transmission, and this variation in congestion conditions in turn causes variations in the delay profile for network data traffic. Allocating slices on demand according to the technology disclosed herein enables more granular control of slicing in terms of the slice duration and the degree of delay improvement which would be necessary to maintain the minimum acceptable user experience especially when an augmented reality (AR) application involves the user moving in an open area, such as an open field or other expansive outdoor location. Moreover, a network customer will be able to select a desired level of service from a number of slices of varying characteristics and cost according to the customer’s own technical priorities and business interests.

In an exemplary scenario of the technology disclosed herein, when an application service hosting a cloud-based application seeks a slice of network resources by which to communicate with a user device, the application service transmits a request for a time-bound network slice to a traffic modeler of the wireless communication network. The request includes a maximum allowable delay which the application service specifies to ensure at least a minimum quality of service for the end-user. The request also includes a slice duration which indicates the length of time the slice is to be provided for hosting data transmission. Upon receiving the request, the traffic modeler infers traffic loading (e.g., processor loading, scheduler loading of a gNodeB access point) for the day, time, and location (e.g., geographic region) of the data transmission. In various implementations, the traffic modeler of the wireless network is an artificial intelligence (AI) model trained to predict network congestion levels for a given day, time, location, and duration based on a historical network traffic data. The network then queries the DSC model based on the traffic load projections from the traffic load modeler and the maximum allowable delay. The DSC model returns round-trip time (RTT) profiles (i.e., delay and jitter profiles) for allocable slices supported by the network and identifies one or more candidate slices which can be dynamically configured to accommodate the maximum allowable delay and slice duration.

For each candidate slice identified by the DSC model in response to a request for a dynamically allocated slice, the model determines a projected delay improvement for the specified duration. In identifying the candidate network slices, the DSC model also determines the costs to the user (e.g., the application service) associated with each of the identified slices based on the respective performance criteria and/or projected delay improvement of the slices. For example, a slice with a more aggressive or more favorable delay profile (e.g., shorter delays coupled with a smaller range of delays, a higher probability of not exceeding maximum allowable delay) may be more expensive than a less favorable or less risky delay profile. When the application service selects a slice from among the one or more candidate slices identified by the DSC model, the wireless communication network dynamically allocates the slice for the specified duration which will support data transmission in accordance with the specified maximum delay.

In various implementations, the traffic modeler is a neural-network computing architecture that receives an input vector including congestion data (e.g., processor load and/or other network traffic KPIs) according to the day, time, and location of the requested service along with the duration specified in the request and returns a projected network congestion or traffic loading profile. In some scenarios, the traffic modeler may be a deterministic model which extrapolates projections from historical market traffic data or a generative AI model trained from historical market traffic data.

In an implementation, the DSC model is an empirical model which infers RTT profiles for allocable network slices based on congestion level (e.g., projected congestion from the traffic modeler) and identifies candidate slices based on the maximum allowable delay specified in the request. Building the DSC model for identifying network slices for a given delay and congestion is a multi-step process broadly including configuring sets of 5G Quality of Service Identifier (5QI) classes to represent network slices, executing a laboratory simulation of different levels of network congestion by varying ratios of TCP (Transmission Control Protocol) and UDP (User Datagram Protocol) traffic and data rates, and computing RTT profiles (i.e., delay and jitter profiles) for the sets of 5QI classes for different levels of network congestion to obtain a delay profile for slices. The 5QI classes specify Quality of Service (QoS) criteria relating to packet delay, packet loss, and data rate as well as other performance criteria. As such, the 5QI classes can be used to specify the levels of service to be provided for different types of data flow according to the type of traffic being carried, such as web browsing, streaming video, interactive gaming, voice transmission, and so on. For example, a set of 5QI classes for a network slice for cloud-based XR services may include the following 5QI classes: 3, 69, 79, 80, and 87-90. Each of the classes specifies values for a set of network performance metrics. When aggregated into sets to simulate a network slice, the sets scope the expected or required performance for a given type of data transmission to be carried by the slice.

In an exemplary implementation of developing the DSC model, 5QI classes are selected to create sets which represent or simulate network slices. With a number of 5QI sets defined, tests are conducted on a simulated 5G network to determine the RTT for a given congestion level (e.g., 20% processor load) over a range of TCP/UDP ratios for each of the simulated slices, i.e., the 5QI sets. (Varying the TCP/UDP mixture of the simulated data traffic produces a range of RTTs; generally speaking, the greater the proportion of UDP traffic in the mixture, the greater the delay.) During the tests, RTT is recorded for multiple transmissions or pings across the simulated 5G network using the simulated slice and without using the simulated slice to capture a baseline or “best effort” RTT. From the data obtained from the tests, a number of RTT metrics are derived, such as the mean and standard deviation of the RTT, the ith percentile of RTT, and so on. In this manner, a body of test data categorized in three dimensions, i.e., by delay, congestion (i.e., network traffic load), and network slice, is obtained.

Next, various RTT metrics are captured according to network slice and congestion level. For example, a median delay and jitter and 95^{th} percentile of delay and jitter may be calculated for a particular slice at a 20% network congestion level. Based on the derived metrics, an RTT improvement effected by a particular slice over a baseline level of service can be determined. For example, if the 95^{th} percentile of delay of a given slice is 31 ms (milliseconds) and the baseline delay for the same level of congestion is 45 ms, this indicates that 31% improvement in delay can be achieved with 95% confidence (or with a probability of 95%). Jitter, the difference between a measured delay and a nominal delay, can be calculated based on the delay data. A jitter profile can then be constructed from which metrics describing jitter can be derived to further quantify improvement. For example, if the 95^{th} percentiles of jitter for a given slice and for the baseline level of service are 8 ms and 10 ms, respectively, then a 20% improvement in jitter can be achieved by the slice with a 95% level of confidence. In this manner, the RTT profiles (delay and jitter profiles) of the defined slices for a projected level of congestion can be determined.

With the delay and jitter profiles determined according to network slice and congestion, the network slices which can accommodate the requested maximum allowable delay can be identified, and the corresponding delay and jitter profiles can be used to price the slices. The identified slices may be presented in a user interface where the customer can select a slice based on projected RTT improvement, projected RTT range (e.g., delay ± jitter), probability of meeting or maintaining the RTT improvement, and cost. In presenting the RTT metrics of the slices, the RTT may include both fixed and non-fixed or cellular RTT projections. The fixed RTT projections are computed for non-cellular portions of the transmission loop between the end-user device and the application service, and the non-fixed RTT projections are computed for cellular portions of the transmission loop. The methods described above are used to determine the non-fixed RTT projections. In various implementations, an application programming interface (API) may be defined by which the customer (e.g., an XR application service or provider) can request and receive slice information for a specified maximum allowable delay and duration.

Technical effects of the technology disclosed herein include enabling on-demand network slicing hosted by a wireless communication network based on AI-generated projections of network congestion and slice performance projections. In operation, a client application can request a network slice or a price quote for a slice and receive a raft of candidate slices meeting the performance requirements (e.g., maximum allowable delay) of the application along with the slice costs. When the wireless network receives a selection of a candidate slice from the client application, network resources can be allocated for the client application for the specified duration. Thus, the technology disclosed herein provides the client application with the ability to request and receive a network slice optimized to accommodate the client application’s technical requirements and budget in view of a projected level of network congestion when and where service is to be provided. Moreover, the ability to offer choices that map service quality to cost and duration will accommodate both customers who are more cost-sensitive as well as those willing to pay more for better service as the need arises.

Moreover, the technology disclosed herein provides a more granular understanding of network congestion and finer control of network slice performance to provide clients applications with delay improvements of finite duration. In doing so, localized and/or limited-duration periods of reduced congestion can be monetized to provide client applications with delay improvements of finite duration. Thus, in contrast to a one-size-fits-all slice allocation, a client application can request and receive delay improvements by leveraging periods of reduced network congestion based on projections from historical traffic data.

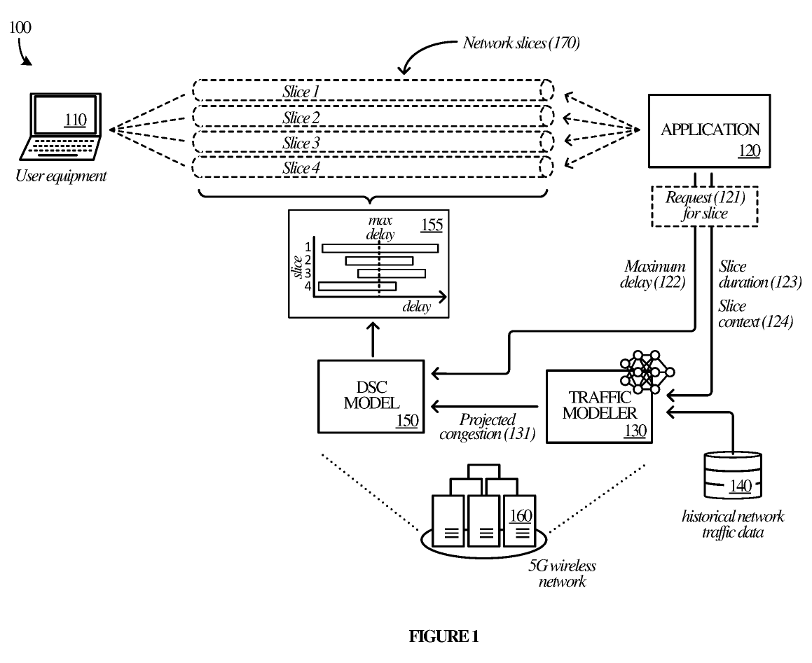

Turning now to the Figures, FIG. 1 illustrates operational environment 100 for time-bound dynamic slicing for wireless communication networks. Operational environment 100 includes wireless network 160, application 120, and user equipment 110. Wireless network 160 includes DSC model 150 and traffic modeler 130. Wireless network 160 provides wireless service, such as wireless service between a 5G access network (e.g., a 5G cell tower) and user equipment 110, via network slices 170.

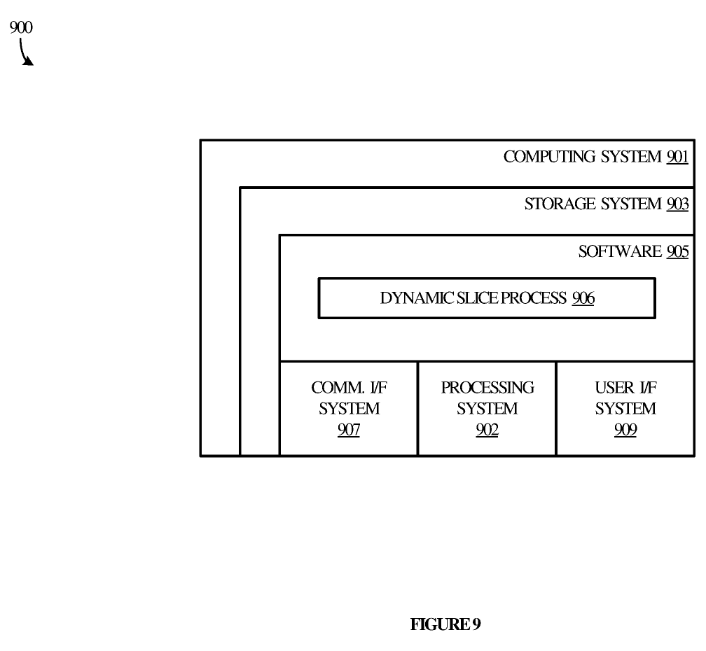

User equipment 110 is representative of a device, such as a smartphone, computer, sensor, controller, radio, and/or some other user apparatus, with processing circuitry for wireless communication with wireless network 160 using protocols such as Fifth Generation New Radio (5GNR), 5G Advanced, LTE, 6G, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). User equipment 110 can include devices such as Internet of Things (IoT) devices, wearable devices, smart vehicles, robots, sensors, augmented or virtual reality devices, and the like, such as a laptop or desktop computer, or mobile computing device, such as a tablet computer or cellular phone, of which computing system 901 in FIG. 9 is broadly representative. User equipment 110 exchanges wireless communication signals with access nodes of wireless network 160 over radio frequency bands.

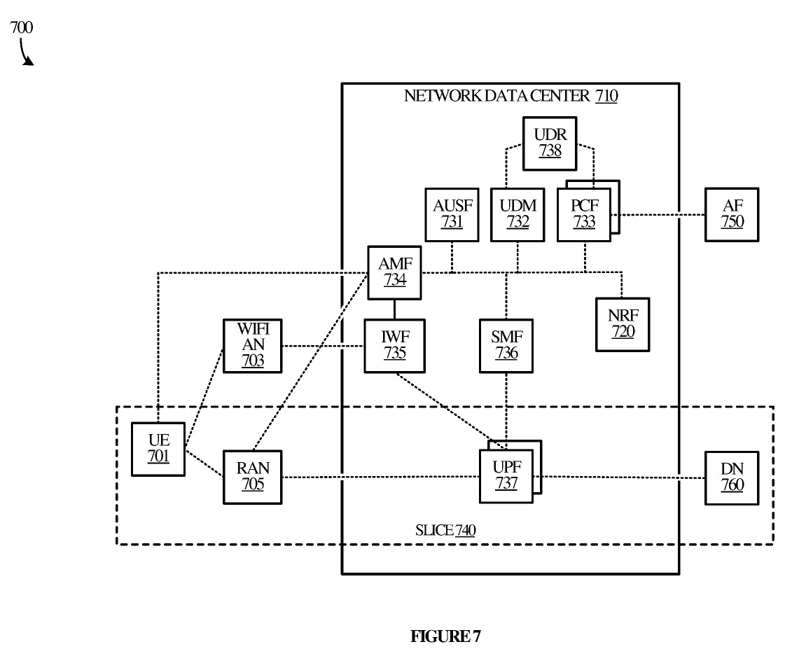

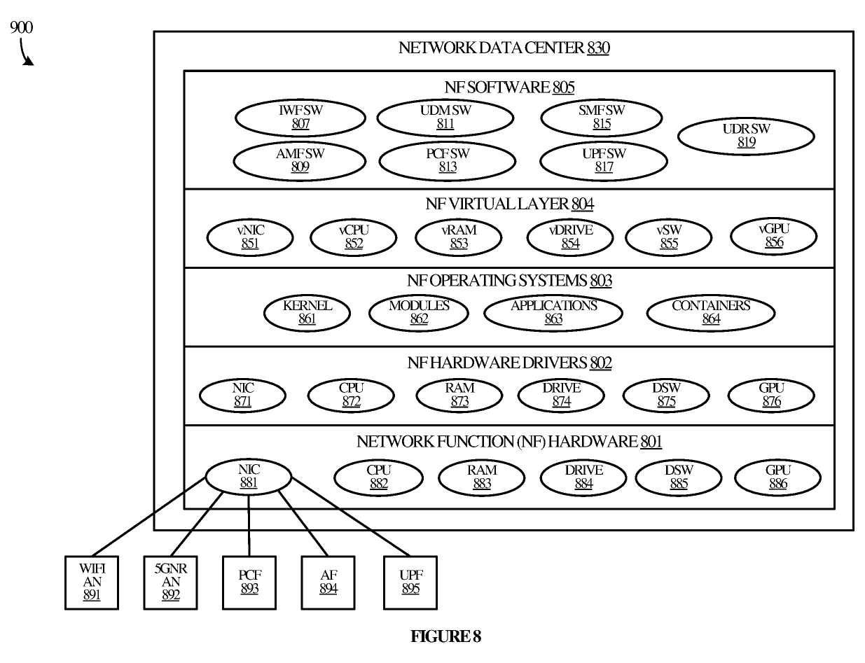

Wireless network 160 is representative of a communication network capable of using a Fifth Generation New Radio (5G-NR), LTE, 6G, or other protocol to communicate with computing devices such as user equipment 110. In an implementation, wireless network 160 is representative of a service-based architecture (SBA) which includes network functions which constitute the control plane and user plane of a wireless communication network core, of which network data center 710 of FIG. 7 and network data center 830 of FIG. 8 are representative. The network functions of wireless network 160 are implemented on one or more suitable computing devices, of which computing device 901 of FIG. 9 is representative. Examples of suitable computing devices include server computers, blade servers, and the like. The network elements of wireless network 160 may be implemented in the context of one or more data centers in a co-located or distributed manner, or in some other arrangement.

Functions or elements of wireless network 160 include traffic modeler 130, data-slice-congestion (DSC) model 150, and historical network traffic data 140. Traffic modeler 130 is representative of a functionality or service of wireless network 160 for projecting network congestion according to a day, time, location, and duration of service. In various implementations, traffic modeler 130 is an AI model or generative AI model trained based on data from historical network traffic data 140 to return a projected level of network congestion. DSC model 150 is representative of a functionality or service of wireless network 160 for generating an RTT profile for a request for a time-bound network slice from application 120. In various implementations, DSC model 150 is an empirical model which projects RTT profiles for network slices such as network slices 170. Historical network traffic data 140 is representative of a network function or element of wireless network 160 which stores data relating to network congestion (e.g., processor or scheduler load) and other network KPIs according to day, time, and location or region for training traffic modeler 130. Historical network traffic data 140 may be implemented on one or more suitable computing devices, of which computing device 901 of FIG. 9 is representative. Examples include server computers, blade servers, and the like.

Network slices 170 are representative of instances of network resource allocations operating on the physical network infrastructure of the wireless communication network. Each slice of network slices 170 has a dedicated allocation of resources, such as bandwidth, processing power, and security, that is managed independently of the other slices. Each slice may be optimized for a particular type of use, such as low-latency, high reliability service for industrial automation or high-bandwidth service for video streaming. Network slicing also accommodates the separation of service providers and infrastructure providers. The control plane (not shown) of wireless network 160 manages network slicing, including time-bound dynamic slicing, and network slice selection and allocation, that is, selecting or allocating the appropriate slice of network slices 170 for hosting service between user equipment 110 and application 120 based on their respective requirements.

Application 120 is representative of an application or application service communicating with user equipment 110 via wireless network 160. For example, wireless network 160 may host communication between application 120 and user equipment 110 via a network slice of network slices 170. The quality of a user experience of application 120 may depend on having a low-latency connection with user equipment 110. For example, if application 120 is an extended-reality gaming application, excessive delay in data transmission between user equipment 110 and application 120 will adversely affect the user experience.

In a brief operational scenario of operational environment 100, wireless network 160 receives request 121 for a dynamically allocated network slice for communication with user equipment 110. Request 121 specifies delay 122, slice duration 123, and slice context 124. Delay 122 may indicate the maximum delay (e.g., 30 ms, 60 ms) for maintaining at least a minimal user experience, while slice duration 123 may indicate the length of time that application 120 would like the requested slice to be available (e.g., 10 minutes, 30 minutes). Slice context 124 indicates where and when the requested slice will host service.

Upon receiving request 121, traffic modeler 130 generates projected congestion 131 based on slice duration 123 as well as slice context 124, i.e., the context of service to be supported by the requested slice, such as the day, time, and location of service (e.g., geographic coordinates of a location, a geographic location with a specified radius). DSC model 150 receives projected congestion 131 from traffic modeler 130 along with delay 122 specified in request 121 and generates RTT profiles 155 for network slices 170. RTT profiles 155 include delay profiles and jitter profiles for each of network slices 170 and other performance attributes along with a cost of service for each slice. RTT profiles 155 provide an indication of the likelihood that a given slice will maintain service meet the requirements of request 121, e.g., maximum delay 122.

Application 120 receives RTT profiles 155 from wireless network 160 and selects a slice of network slices 170 according to the cost, delay profile, and other slice performance attributes of RTT profiles 155. Upon receiving the selection of a slice of network slices 170 from application 120, wireless network 160 allocates network resources to create the selected slice and signals to application 120 that the slice is available for use. In various implementations, application 120 may request, select, and schedule multiple slices for real-time, near real-time, or future use via the technology disclosed therein. In addition, as the selected slice supports data transmission between application 120 and user equipment 110, wireless network 160 may collect slice performance data and network traffic data to refine or improve DSC model 150 and to update historical network traffic data 140 for training traffic modeler 130.

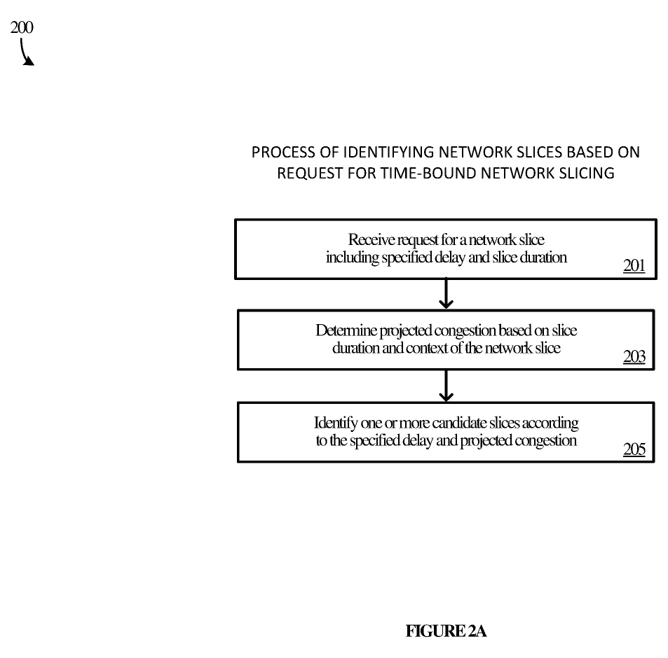

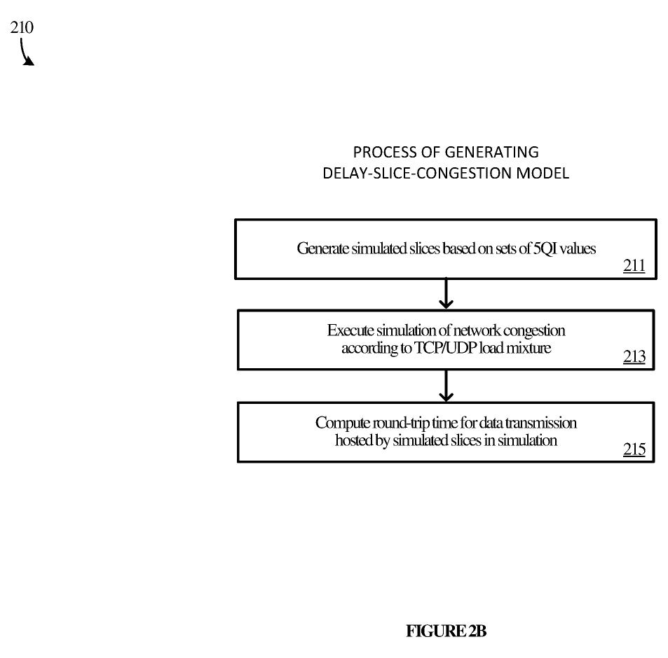

FIG. 2A illustrates a method of dynamic slicing of finite duration for wireless communication networks in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

In process 200, a wireless communication network receives a request for a network slice including a specified delay and slice duration (step 201). In an implementation, the wireless network, such as a 5G-NR network, receives the request from an application or application service via an application programming interface (API) hosted by the network. Using the API, the requestor can obtain price quotes for network slices which may be allocated to host data transmission with an endpoint such as a user computing device. For example, the requesting application or service may be a virtual reality, augmented reality, mixed reality, or extended reality gaming application which relies on low latency data transfer to provide a minimally acceptable user experience. Such an application may request a slice to host a low-latency communication with the end-user device to ensure at least a minimum quality of service. The request may include a specified delay which the allocated slice is to provide for hosting communication via the requested slice. The request may also include a slice duration or period of hosting service.

The request for the network slice may also include the slice context, i.e., contextual information relating to when (e.g., a day and time) and where (e.g., a geographic region corresponding to an access network where the end-user device is located) the service is to be hosted by the requested slice. The geographic region specified in the slice context may be a specified location or an area (e.g., an area within a specified radius of a specified location) in which the maximum allowable delay is to be maintained. In some scenarios, the contextual information for the slice may be obtained in other ways, e.g., the application service hosting the application may provide the context via another API.

The wireless network determines a projected congestion based on the slice duration and the context of the network slice to be dynamically allocated (step 203). In an implementation, a traffic modeler determines a projected congestion based on historical network traffic data. The traffic modeler may be a deep learning model, such as a neural network model, trained to determine traffic conditions for a given context. For example, the model may receive an input or feature vector with values indicative of where (e.g., geographic region) and when (e.g., day and time) along with the slice duration specified in the request. The output of the AI model may be a congestion level, such as a processor load or scheduler load. To construct the traffic modeler, the AI model may be trained using historical network data to generate a projected congestion level for a to-be-allocated slice. In some scenarios, the traffic modeler may be a generative AI model which is trained or fine-tuned to generate a congestion level based on the contextual information and slice duration. Alternatively, the traffic modeler may be a deterministic model which extrapolates traffic conditions for the context of the service to be hosted by the requested slice.

The wireless network identifies one or more candidate network slices for the requested network slice according to the specified delay and the projected congestion (step 205). In an implementation, with the projected congestion level determined, the wireless network identifies network slices from available or allocable slices (i.e., slices which the network can allocate and support) which can accommodate the parameters of the request, i.e., the specified delay, the slice duration, and the context of the to-be-allocated slice. To identify the candidate slices, the wireless network may call an empirical model which generates RTT profiles of the available slices based on a three-dimensional dataset correlating transmission delay, slices or slice attributes, and congestion level. In calling the empirical model, the model receives projected congestion level and returns an RTT profile for various network profiles. The RTT profiles may include delay profiles for the network slices which indicate the likelihood of maintaining transmissions below the specified delay.

In evaluating slice performance with respect to the specified delay, the network or the empirical model may eliminate from consideration any network slices with excess latency in transmission. For example, if the 50^{th} percentile of the projected delay of a network slice is greater than the specified delay, the slice may be removed from consideration, i.e., not presented to the requestor. In some scenarios, the network slices may be ranked according to their ability to maintain transmission below the specified delay and presented to the requesting application according to their ranking.

In various implementations, the wireless network or the empirical model also determines a cost associated with each of the identified slices. For example, the cost may be determined based on the performance parameters of the identified slices such that a more aggressive slice profile which provides a more favorable delay profile with respect to the specified delay may be more costly than a slice with less aggressive profile and a less favorable delay profile. In other words, there is likely a trade-off between the cost and the performance of the slices. As such, the wireless network may identify multiple network slices with a range of delay performance and a range of costs for the convenience of the requestor.

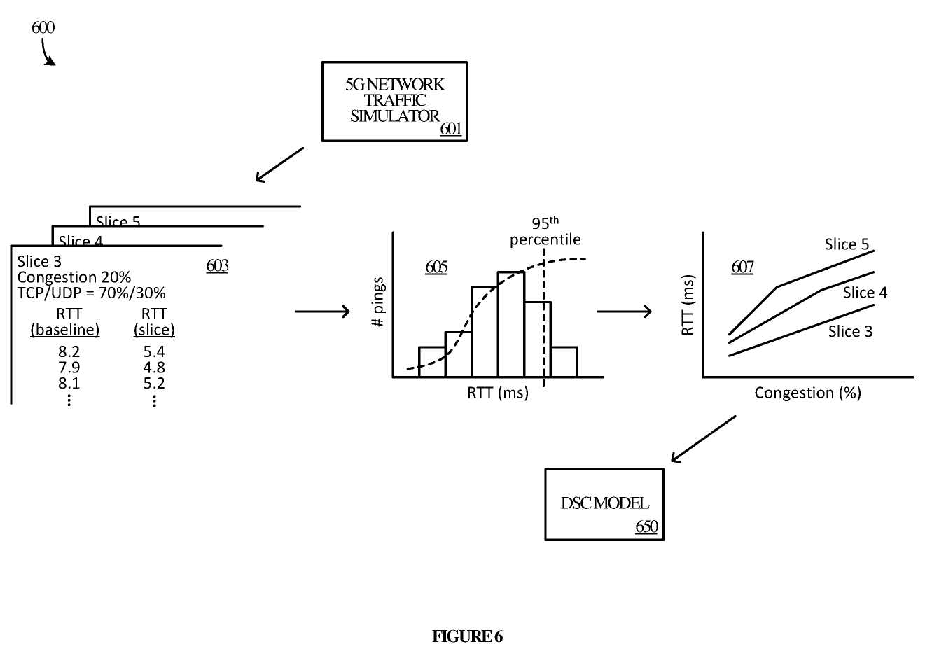

In various implementations, to generate the RTT profiles of the network slices, the empirical model may access a three-dimensional dataset of data according to delay, slice attributes, and congestion level. The dataset may be generated based on transmission tests (e.g., ping tests) performed in a simulated network environment with simulations of the network slices, implementations of which are described in process 210 of FIG. 2B and process 600 of FIG. 6.

Continuing with process 200, in an implementation, when the wireless network identifies multiple slices in response to the request, the network recommends the candidate slices to the requesting application along with the slice attributes, RTT profiles, and cost information. The network may then receive a selection of a candidate slice from the requestor which the network allocates for service at the designated time and location.

Referring again to FIG. 1, operational environment 100 illustrates a brief example of process 200 as employed by elements of operational environment 100. In operation, wireless network 160 receives request 121 from application 120 for a network slice to be dynamically allocated to host service between application 120 and user equipment 110. Request 121 may include maximum delay 122 indicating the maximum latency in communication with user equipment 110 and slice duration 123 indicating the length of time the slice is to be available to host service. Request 121 may also include slice context 124 providing contextual information (not shown) indicating where and when the service is to be hosted by the to-be-allocated slice.

In response to request 121, wireless network 160 determines projected congestion 131 based on slice duration 123 and slice context 124 (e.g., where and when) of the to-be-allocated slice. To determine projected congestion 131, traffic modeler 130 of wireless network 160 receives slice duration 123 and slice context 124. Based on its training on historical network traffic data 140, traffic modeler 130 generates projected congestion 131 indicating the level of network congested based on slice duration 123 and slice context 124.

Next, wireless network 160 identifies network slices 170 for hosting service for application 120 according to maximum delay 122 and projected congestion 131. To identify network slices 170, DSC model 150 of wireless network 160 receives projected congestion 131 from traffic modeler 130 along with maximum delay 122 from request 121. DSC model 150 generates RTT profiles 155 for network slices which can be allocated by wireless network 160 for the requested service. To generate RTT profiles 155, DSC model 150 accesses a three-dimensional dataset of data categorized by delay, slice attributes, and congestion level. For example, for a given congestion level and allowable delay, DSC model 150 will return delay profiles for network slices which can maintain traffic according to the allowable delay. The dataset of DSC model 150 may be generated based on transmission tests (e.g., ping tests) performed in a simulated network environment with simulations of the network slices, implementations of which are described in process 210 of FIG. 2B and process 600 of FIG. 6.

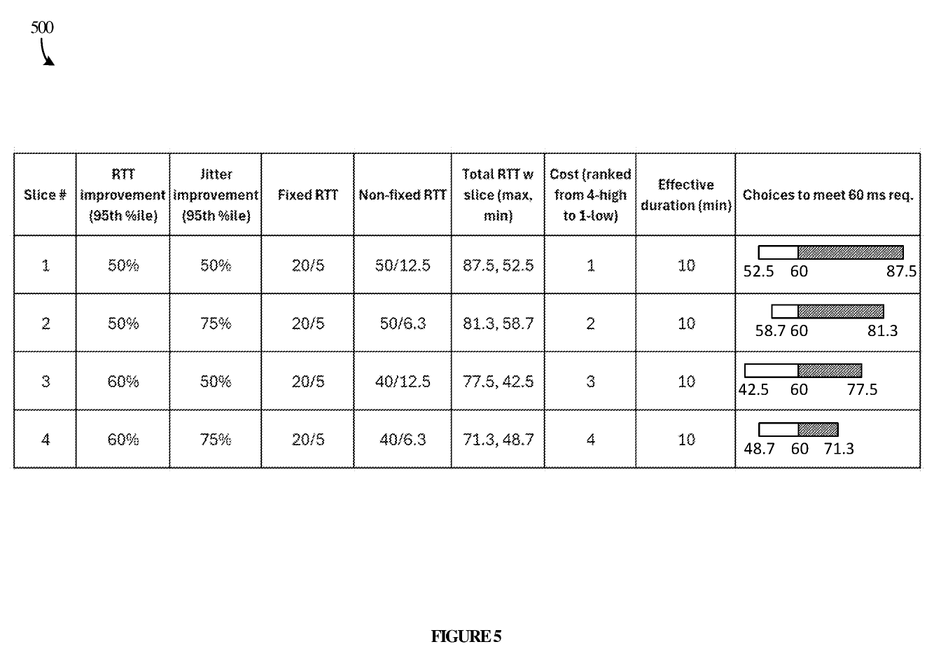

Continuing with process 200 in the context of operational environment 100, having identified network slices 170 which can accommodate request 121, wireless network 160 (or DSC model 150) computes a cost for each network slice and returns the information to application 120 (an embodiment of which is illustrated in FIG. 5). Application 120 may then select a network slice of network slices 170 for hosting service to user equipment 110.

FIG. 2B illustrates a method of constructing a DSC model for dynamic slicing of finite duration in an implementation, herein referred to as process 210. Process 210 may be implemented in program instructions in the context of any of the software applications, modules, components, or other such elements of one or more computing devices. The program instructions direct the computing device(s) to operate as follows, referred to in the singular for the sake of clarity.

A computing device generates simulated slices based on sets of 5QI values (step 211). In an implementation, multiple sets of 5QI values are aggregated to represent the performance characteristics of network slices for hosting various kinds of data traffic. For example, a set of 5QI classes for a network slice for cloud-based XR services may include the following 5QI classes: 3, 69, 79, 80, and 87-90. Each of the classes specifies values for a set of network performance metrics. When aggregated into sets to simulate a network slice, the sets define the expected or required performance for a given type of data transmission to be carried by the slice.

Next, the computing device executes a simulation of network congestion according to various TCP/UDP load mixtures (step 213). In an implementation, network data traffic is generated using a data traffic generator (e.g., iperf) to inject traffic across each of the simulated slices of the simulated network. To capture a comprehensive profile of slice behavior, the TCP/UDP ratio is modulated while holding the congestion level constant. For example, for a congestion level of 20%, the TCP/UDP ratio may be stepped through values ranging from 30%/70% to 70%/30%. Thus, delay metrics are captured according to two variables, congestion level and network slice.

Next, the computing device computes RTT data for data transmissions hosted by the simulated slices in the simulation (step 215). During the ping tests, round-trip time data for pings sent from a ping generator to an endpoint in the simulated network is captured for the simulated slices at varying levels of simulated network congestion. Using the test data, delay profiles can be generated for a given slice at a specified level of network congestion, an example of which is depicted in RTT profile 605 of FIG. 6. The delay profile illustrates a distribution (e.g., histogram) of delays measured during multiple ping tests on the simulated network. The results of the tests typically result in a roughly normal distribution of values which correspond to TCP/UDP ratio in that the peak of the distribution tends to occur for TCP/UDP ratios around 50%/50%, and the tails of the distribution corresponding to ratios around 70%/30% and 30%/70%. Based on the distributions, metrics characterizing the distribution such as median and 95^{th} percentile delay values can be determined.

Jitter profiles can be generated from the delay data based on differences (i.e., absolute value of differences) between the with-slice and baseline measurements. The distribution of jitter in a jitter profile tends to peak at the lowest values of jitter and decline as the jitter values increase. Here, too, metrics characterizing the distribution such as the median and 95^{th} percentile can be determined.

Having generated distributions and descriptive metrics for the various simulated network slices according to network congestion, the DSC model can be used to predict the delay and jitter according to the network slice at a specified level of network congestion.

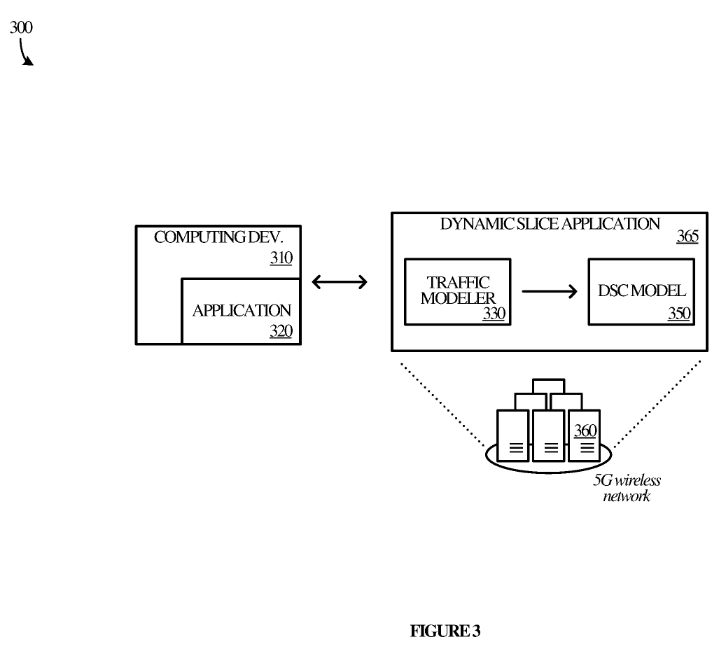

FIG. 3 illustrates operational environment 300 for selecting and allocating time-bound network slices in an implementation. Operational environment 300 includes application 320, of which application 120 of FIG. 1 is representative, and dynamic slice application 365 which is executed by wireless network 360, of which wireless network 160 of FIG. 1 is representative. Application 320, executing computing device 310 remote from wireless network 360, communicates with dynamic slice application 365 to request and receive price quotes for network slices. Dynamic slice application 365 includes traffic modeler 330, of which traffic modeler 130 of FIG. 1 is representative, and DSC model 350, of which DSC model 150 of FIG. 1 is representative.

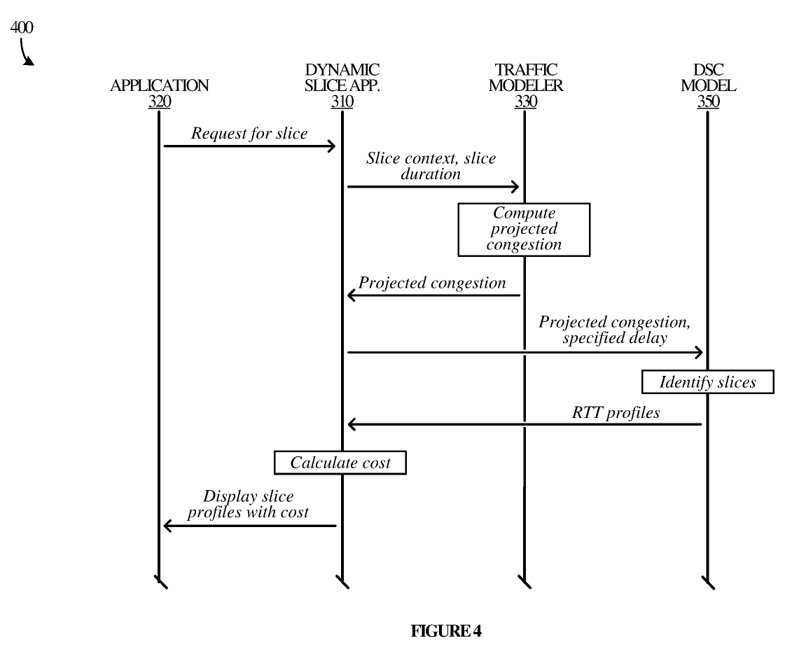

FIG. 4 illustrates workflow 400 for selecting an allocating time-bound network slices in an implementation, referring to elements of operational environment 300. In workflow 400, application 320 transmits a request for a dynamically allocated slice for hosting service to an endpoint such as a user computing device (not shown). The request may be transmitted via an API hosted by dynamic slice application 365. The request may include a maximum allowable or maximum acceptable delay in data transmission, a duration for the slice to host service, and the context in which the slice will be operating (i.e., where and when). The request may also specify the volume of data traffic that the slice will be projected to host.

Upon receiving the request, dynamic slice application 365 sends the slice context and slice duration from the request to traffic modeler 330 which projects the level of network congestion the to-be-allocated slice will be operating in based on extrapolating from historical traffic data. Traffic modeler 330 returns the projected congestion level to dynamic slice application 365.

Dynamic slice application 365 sends the projected congestion received from traffic modeler 330 and specified delay from the request to DSC model 350. Based on the information provided, DSC model 350 evaluates RTT profiles for various ones of the available network slices for the specified level of network congestion and identifies network slices which may accommodate the service requested. The RTT profiles may include delay profiles and jitter profiles of the respective slices and/or other information such as percentage improvements in the delay and jitter based on the delay and duration requirements from the request. DSC model 350 recommends one or more network slices along with slice attributes and projected performance parameters (e.g., delay profile, jitter profile) to dynamic slice application 365.

Upon receiving the recommended network slices from DSC model 350, dynamic slice application 365 determines a cost for the recommended slices, such as cost per minute, per volume of data traffic, etc., based on the respective attributes and/or performance parameters of the slices. Dynamic slice application 365 then returns the list of recommended network slices along with the cost to application 320. A representation of the information returned to application 320 is depicted in RTT profiles 500 of FIG. 5.

FIG. 5 illustrates RTT profiles 500 for various network slices generated according to an implementation of the technology disclosed herein. RTT profiles 500 may be generated in response to a request for a dynamically allocated slice by a client application of a wireless communication network. As illustrated the request may specify that the desired or maximum allowable delay of data traffic carried by the slice is 60 ms for a slice duration of 10 minutes. Not shown in RTT profiles 500 is the particular context for the requested service (the day, time, and location of service). RTT profiles 500 may be generated by a DSC model based on empirical data obtained from a laboratory simulation of network slices on a network with simulated network congestion, e.g., according to process 210 of FIG. 2B discussed above.

RTT profiles 500 includes performance metrics for four recommended slices. For each slice, RTT profiles 500 includes the delay improvement (“RTT Improvement”) and jitter improvement of the slice according to the 95^{th} percentile of the delay and jitter distributions for the respective slice for a projected level of congestion.

RTT profiles 500 also includes “Fixed RTT” and “Non-fixed RTT” metrics which project the delay and jitter projections for the cellular and non-cellular portions of the transmission loop, i.e., between the requesting application and the end-user device. The non-fixed metrics reflect the projected delay and jitter derived from the DSC model. “Total RTT w slice” computes a total projected delay based on the delay and jitter values of the fixed and non-fixed portions.

RTT profiles 500 also includes a relative cost of the network slices indicating the least expensive to the most expensive slices. The relative cost (or an absolute cost) may be determined based on the 5QI performance metrics corresponding to the respective slices. Thus, a slice with a more restrictive or more demanding performance profile may have a higher cost than one with more relaxed requirements.

RTT profiles 500 also illustrates the delay profiles of the recommended slices with respect to the requested delay (60 ms). As a pictorial graphic in the rightmost column, each delay profile depicts the range of delay projected for a given slice for the given congestion level as quantified by the “Total RTT w slice.” Each pictorial graphic provides a visual representation of the likelihood that the slice will be able to accommodate the requested delay. For example, for slice #4, the delay profile is the narrowest of the four slices, and the maximum allowable delay falls roughly in the middle, indicating a roughly 50% likelihood of accommodating the requested delay. In contrast to slice #4, slice #1 depicts the broadest range of possible delays of the four slices with much lower likelihood of accommodating the requested delay. Given the comprehensive presentation of performance metrics of the recommended slices along with the relative or actual cost, the requesting application can select a slice to be dynamically allocated for hosting service to the end user device.

FIG. 6 illustrates process 600 for constructing an empirical model for time-bound dynamically allocated network slices in an implementation. Process 600 may be performed by a wireless communication network to construct an empirical model for projecting an RTT profile or related metrics. Using the empirical model, the wireless communication network can identify network slices in response to a request for dynamically allocated slice.

In process 600, 5G network traffic simulator 601 generates simulated network traffic to capture RTT data 603 for a number of simulated network slices. To generate RTT data 603, transmission or ping tests are conducted across the simulated network both with and without each of the simulated network slices. For each simulated network slice, the tests are conducted according to varying levels of simulated network congestion for varying TCP/UDP ratios. As such, the dataset of RTT data 603 includes RTT data according to network slice, simulated network congestion level, and TCP/UDP level.

Next, RTT profile 605 is representative of an RTT profile which may be generated for a given network slice at a specified level of simulated network congestion based on RTT data 603. As depicted, RTT profile 605 includes a representative histogram or distribution of delay times for a given slice according to the specified level of congestion. Based on the distribution, metrics which summarize slice performance with respect to delay can be derived. For example, a 95th percentile of delay times can be determined. In generating RTT profile 605, data values across the various TCP/UDP ratios are aggregated according to congestion level to simulate the uncertain nature of the network traffic the slice will encounter. Aggregating across TCP/UDP ratios accounts for (to some degree) this uncertainty.

Optionally, a summary comparison of slice performance may be generated as depicted in graph 607. In graph 607, a delay metric (e.g., median, 95th percentile) can be plotted according to congestion level and network slice. Graph 607 provides a visual indication of relative slice performance according to network congestion level.

In operation, DSC model 650 projects RTT profiles based on metrics derived from RTT data 603 for which visual representations of the data and metrics are depicted in RTT profile 605 and graph 607. Thus, when a wireless communication network hosting DSC model 650 receives a request for dynamically allocated network slice, the network can consult DSC model 650 to recommend slices according to the specified delay, for example, as depicted in RTT profiles 500 of FIG. 5.

FIG. 7 illustrates exemplary wireless communication system 700 that serves wireless User Equipment (UE) 701 based on policies. Wireless communication system 700 includes UE 701, Wifi Access Node (AN) 703, 5GNR RAN 705, Interworking Function (IWF) 735, Access and Mobility Management Function (AMF) 734, Authentication Server Function (AUSF) 731, Unified Data Management (UDM) 732, Policy Control Functions (PCFs) 733, Session Management Function (SMF) 736, User Plane Function (UPF) 737, Uniform Data Repository (UDR) 738, and Application Function (AF) 750. UDR 738 stores network data including subscriber profiles including identities, subscription details, service preferences, authentication credentials, and billing information. UDR 738 may also store policy data such as network rules, access rules, mobility rules, charging rules, and so on. AF 750 may provide policies applicable to control plane functions, that is, to the application, presentation, and/or session layers of the OSI protocol stack. IWF 735 includes non-3GPP IWFs (N3IWFs) for providing untrusted non-3GPP access to network data center 710, such as access via a non-cellular access network.

Continuing with wireless communication system 700, wireless network slice 740 includes UPF 737 and SMF 736. Wireless network slice 740 is representative of a dynamically allocated slice of finite duration selected for hosting service from DN 760 to UE 701 according to the technology disclosed herein, including process 200 or workflow 400. DN 760 is representative of a data network, Internet access, third-party resource, or other endpoint of an end-to-end communication path from UE 701. For example, DN 760 may be an application or application service which requests a time-bound dynamically allocated slice for the wireless network of network data center 710 for service to UE 701.

In an implementation, UE 701 communicates with network data center 710 via 5G-NR access node 705 or Wifi access node 703. UE 701 requests access to DN 760 via the communication network of network data center 710, e.g., via wireless network slice 740. SMF 736 receives the access request from AMF 734 and other network functions of the communication network which are enforcing various aspects of the access request from UE 701. SMF 736 receives policies or policy decisions from AUSF 731, UDM 732, PCF 733, and/or AMF 734.

FIG. 8 illustrates exemplary network data center 830, a network core of a wireless communication system, of which wireless network 160 of FIG. 1 is representative. Network data center 830 includes network function (NF) software 805, network function virtual layer 804, network function operating systems 803, network function hardware drivers 802, and network function hardware 801.

Network function software 805 of network data center 830 includes software for executing various network functions: IWF software 807, AMF software 809, UDM software 811, PCF software 813, SMF software 815, UPF software 817, and UDR software 819. Other network function software, such as network repository function (NRF) software, are typically present but are omitted for clarity.

Network function virtual layer 804 includes virtualized components of network data center 830, such as virtual NIC 851, virtual CPU 852, virtual RAM 853, virtual drive 854, virtual software 855, and virtual GPU 856. Network operating systems 803 includes components for operating network data center 830, including kernels 861, modules 862, applications 863, and containers 864 for network function software execution. Network function hardware drivers 802 include software for operating network function hardware 801 of network data center 830, including network interface card (NIC) drivers 871 for network interface cards (NICs) 881, CPU drivers 872 for CPUs 882, RAM drivers 873 for RAM 883, flash/disk drive drivers 874 for flash/disk drives 884, data switch (DSW) drivers 875 for data switches 885, and drivers 876 for GPUs 886. Network interface cards 881 of network function hardware 801 include hardware components for communicating with Wifi access node 891, 5GNR access node 892, PCF 893, application server 894, and UPF 895.

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements dynamic slice process 906, which is (are) representative of the dynamic slice processes discussed with respect to the preceding Figures, such as processes 200 and 210 and workflow 400. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including dynamic slice process 906) may be implemented in program instructions and among other functions may, when executed by processing system 902, direct processing system 902 to operate as described with respect to the various operational scenarios, sequences, and processes illustrated herein. For example, software 905 may include program instructions for implementing a dynamic network slice process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to support processes for time-bound dynamic network slices in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
receive, from an application, a request for a network slice, wherein the request includes a specified delay and a slice duration;
determine a projected congestion based on a context of the network slice and the slice duration; and
identify one or more candidate slices for the network slice according to the specified delay and the projected congestion.

2. The computing apparatus of claim 1, wherein to identify the one or more candidate slices, the program instructions direct the computing apparatus to:
submit the context of the network slice and the projected congestion to an empirical model, wherein the context of the network slice comprises includes a day, a time, and a location of network service to be hosted by the network slice;
determine, by the empirical model, round-trip time profiles for available slices based on the projected congestion; and
identify the one or more candidate slices from the available slices based on comparing the specified delay to the round-trip time profiles.

3. The computing apparatus of claim 2, wherein the empirical model comprises a dataset of round-trip time data according to congestion level and network slice.

4. The computing apparatus of claim 3, wherein the dataset of the empirical model comprises test data from a wireless network simulation using simulated network slices and simulated data traffic of variable TCP/UDP data ratios.

5. The computing apparatus of claim 1, wherein the program instructions further direct the computing apparatus to generate a cost for each of the one or more candidate slices based on attributes of the one or more candidate slices.

6. The computing apparatus of claim 5, wherein to receive the request for the network slice, the program instructions direct the computing apparatus to receive the request via an application programming interface from a remote computing device.

7. The computing apparatus of claim 5, wherein the program instructions further direct the computing apparatus to return, to the remote computing device, output comprising the attributes of the one or more candidate slices and the cost of each of the one or more candidate slices.

8. A method of operating a computing device comprising:
receiving, from an application, a request for a network slice, wherein the request includes a specified delay and a slice duration;
determining a projected congestion based on a context of the network slice and the slice duration; and
identifying one or more candidate slices for the network slice according to the specified delay and the projected congestion.

9. The method of claim 8, wherein identifying the one or more candidate slices comprises:
submitting the context of the network slice and the projected congestion to an empirical model, wherein the context of the network slice comprises includes a day, a time, and a location of network service to be hosted by the network slice;
determining, by the empirical model, round-trip time profiles for available slices based on the projected congestion; and
identifying the one or more candidate slices from the available slices based on comparing the specified delay to the round-trip time profiles.

10. The method of claim 9, wherein the empirical model comprises a dataset of round-trip time data according to congestion level and network slice.

11. The method of claim 8, wherein the dataset of the empirical model comprises test data from a wireless network simulation using simulated network slices and simulated data traffic of variable TCP/UDP data ratios.

12. The method of claim 8, further comprising generating a cost for each of the one or more candidate slices based on attributes of the one or more candidate slices.

13. The method of claim 12, wherein receiving the request for the network slice comprises receiving the request via an application programming interface from a remote computing device.

14. The method of claim 13, further comprising returning, to the remote computing device, output comprising the attributes of the one or more candidate slices and the cost of each of the one or more candidate slices via the application programming interface.

15. One or more computer readable storage media having program instructions stored thereon that, when executed by one or more processors, direct a computing apparatus to at least:
receive, from an application, a request for a network slice, wherein the request includes a specified delay and a slice duration;
determine a projected congestion based on a context of the network slice and the slice duration; and
identify one or more candidate slices for the network slice according to the specified delay and the projected congestion.

16. The one or more computer readable storage media of claim 15, wherein to identify the one or more slices, the program instructions direct the computing apparatus to:
submit the context of the network slice and the projected congestion to an empirical model, wherein the context of the network slice comprises includes a day, a time, and a location of network service to be hosted by the network slice;
determine, by the empirical model, round-trip time profiles for available slices based on the projected congestion; and
identify the one or more candidate slices from the available slices based on comparing the specified delay to the round-trip time profiles.

17. The one or more computer readable storage media of claim 16, wherein the empirical model comprises a dataset of round-trip time data according to congestion level and network slice.

18. The one or more computer readable storage media of claim 15, wherein the dataset of the empirical model comprises test data from a wireless network simulation using simulated network slices and simulated data traffic of variable TCP/UDP data ratios.

19. The one or more computer readable storage media of claim 15, wherein the program instructions further direct the computing apparatus to generate a cost for each of the one or more candidate slices based on attributes of the one or more candidate slices.

20. The one or more computer readable storage media of claim 19, wherein to receive the request for the network slice, the program instructions direct the computing apparatus to receive the request via an application programming interface from a remote computing device, and wherein the program instructions further direct the computing apparatus to return, to the remote computing device, output comprising the attributes of the one or more candidate slices and the cost of each of the one or more candidate slices via the application programming interface.
